(19) United States
(12) Patent Application Publication
(10) Pub. No.: US 2014/0377485 A1
(43) Pub. Date: Dec. 25, 2014

(54) Stress Corrosion Cracking Resistant, Austenitic Steel Components and Weld Seams

(71) Applicant: Endress + Hauser GmbH + Co. KG, Maulburg (DE)

(72) Inventors: Markus Berger, Wehr (DE); Christoph Bollig, Schopfheim (DE); Volker Frey, Schopfheim (DE)

(21) Appl. No.: 14/312,865

(22) Filed: Jun. 24, 2014

(30) Foreign Application Priority Data
Jun. 24, 2013 (DE) 10 2013 106 543.0

(51) Int. Cl. B21D 31/00; F16L 9/02; B23K 31/02

(52) U.S. Cl. CPC B21D 31/00; B23K 31/02; F16L 9/02; B23K 2201/045; B23K 2201/34
USPC 428/34.1; 228/155; 72/377; 428/469; 428/389; 138/177

(57) ABSTRACT

A method for achieving a higher stress corrosion cracking resistance for steel components of corrosion resistant, austenitic steel having an outer oxide layer, especially a chromium oxide layer, especially steel components in the form of steel sheets, steel pipes or steel rods, as well as for weld seams connecting austenitic steel components, wherein the increased stress corrosion cracking resistance is achieved by introducing compressive stresses into an outer layer of the steel component covered outwardly by the oxide layer, respectively into an outer layer of the weld seam, wherein the compressive stresses are introduced by areal pressure exertion on the respective outer layer.

The invention relates to a method for producing steel components of corrosion resistant, austenitic steel protected relative to stress corrosion cracking and having an outer oxide layer, especially a chromium oxide layer. The invention relates also to stress corrosion cracking resistant, austenitic steel components, and to stress corrosion cracking resistant, welded connections between corrosion resistant, austenitic steel components.

Austenitic steel components are applied, for example, as outer walls of housings, especially measuring device housings. Austenitic steels are characterized by a comparatively high percentage of an austenite former, which results in an austenitic metal grain structure. Austenite formers include, for example, nickel, cobalt, manganese and nitrogen.

Corrosion resistant, austenitic steels contain, besides the austenite former, an addition effecting the corrosion resistance. Used for this is, preferably, chromium, wherein the chromium fraction usually is greater than 10%. The addition leads to the forming on the steel surface of an oxide layer, especially a chromium oxide layer, which has a thickness measured in angstroms. This oxide layer is usually referred to as a passive layer.

Present beneath the oxide layer is an austenitic structure of mutually adjoining grains. Precipitates, especially impurities, deposit at the grain boundaries of the individual grains.

In general, tensile stresses occur in austenitic steel components. These arise both in the case of manufacture of these steel components, as well as also as a result of mechanical loadings, which the manufactured steel components are exposed to in their later application. Moreover, tensile stresses also form in the case of cooling of weld seams.

Due to these tensile stresses, present, even in the case of otherwise corrosion resistant, austenitic steels, is the danger of stress corrosion cracking.

Stress corrosion cracking arises when tensilely stressed, corrosion resistant, austenitic steel components, or weld seams connecting tensilely stressed, corrosion resistant, austenitic steel components, are later exposed to a medium attacking the outer oxide layer. Especially dangerous are halide containing media, such as e.g. ocean air and salt water. Thus, for example, chloride ions are able to attack a damaged chromium oxide layer at the damage locations.

If corrosion resistant, austenitic steel components are exposed to a halide containing environment, then the halides can attack the steel at damaged locations of the oxide layer.

If such an attack occurs at a grain boundary in the structure located under the oxide layer, there arises a microcrack, which, due to the tensile stress in the material, propagates along the grain boundaries. A crack forms, which, due to the tensile stresses, propagates comparatively rapidly along the grain boundaries into deeper material layers and lastly leads to fracture of the material.

Stress corrosion cracking represents a special danger, since it occurs comparatively suddenly and it is not initially recognizable, whether, respectively when, it is occurring. When corrosion resistant, austenitic steels are examined with usual non-destructive, material testing methods, such steels appear to be completely intact until shortly before occurrence of material fracture.

In the 2010 research report, ISBN No. 3-937567-88-7, of the publisher, Verlag- und Vertriebsgesellschaft mbH, Duesseldorf, Germany, bearing the Title: ‘REFRESH-Lebensdauerverlängerung bestehender und newer geschweiβter Stahlkonstruktionen’, i.e. ‘REFRESH: lengthening the life of existing and new, welded steel structures’, a method is described, with which the durability of weld seams of carbon steels, such as applied especially in the building industry, is improved relative to crack formation caused by stress raisers. In such case, residual compressive stress is introduced into outer layer material of weld seams by hammer or needle peening. Such peening is accomplished by means of tools with a pin-shaped tip, which is applied pointwise externally on the weld seam with a predetermined repetition rate, in order to compress the outer layer of material.

If one would treat an austenitic steel component in this way, the austenitic structure would transform into deformation induced martensite. Martensite has, however, a lesser corrosion resistance than austenite.

An object of the invention is to provide a method for producing steel components of corrosion resistant, austenitic steel protected relative to stress corrosion cracking and having an outer oxide layer, especially a chromium oxide layer, as well as also stress corrosion cracking resistant, austenitic steel components, and stress corrosion cracking resistant, welded connections between corrosion resistant austenitic steel components.

To this end, the invention resides in a method for producing steel components of corrosion resistant, austenitic steel protected relative to stress corrosion cracking and having an outer oxide layer, especially a chromium oxide layer, especially steel components in the form of steel sheets, steel pipes or steel rods, of corrosion resistant, austenitic steel, wherein compressive stresses are introduced into at least one outer layer of the steel component outwardly covered by the oxide layer, wherein the compressive stresses are introduced by areal pressure exertion on the outer layer.

In such case, the compressive stresses are preferably introduced by means of a roller burnishing device, which has a pressure exerting element, which bears areally on an outside of the outer layer and which is led, while exerting pressure on the layer, over its outside.

In a further development of this method, the compressive stresses are introduced in such a manner that
the layer has a thickness, which lies in an order of magnitude greater than or equal to ten times a grain size of grains present in the steel component, and
the compressive stresses introduced into the layer outweigh existing tensile stresses.

Moreover, the invention includes a method for manufacturing a welded connection between two steel components of corrosion resistant, austenitic steel having an outer oxide layer, especially a chromium oxide layer, especially steel components in the form of steel sheets, steel pipes or steel rods, in the case of which method
the steel components are welded with one another along a weld seam, and
compressive stresses are introduced into an outer layer of the weld seam by areal pressure exertion.

Additionally, the invention resides in a steel component of corrosion resistant, austenitic steel, especially a steel sheet, a steel tube or a steel rod, which has an outer oxide layer (1), especially a chromium oxide layer, and which has, outwardly covered by the oxide layer, at least one outer layer, in which areally introduced, compressive stresses are present.

In a further development of the steel component
the layer has a thickness, which lies in an order of magnitude greater than or equal to ten times a grain size of grains present in the steel component, and
the introduced compressive stresses outweigh tensile stresses existing in the layer.

Additionally, the invention includes a housing having at least one outer wall of a corrosion resistant, austenitic steel, which has, outwardly covered by an oxide layer, especially a chromium oxide layer, an outer layer, in which areally introduced, compressive stresses are present.

Moreover, the invention includes a housing
having two outer walls of corrosion resistant, austenitic steel connected with one another via a weld seam,
each of which has an outer layer covered outwardly by an oxide layer, especially a chromium oxide layer,
wherein in an outer layer of the weld seam compressive stresses are present introduced by areal pressure exertion.

The invention and other advantages will now be explained in greater detail based on the figures of the drawing illustrating an example of an embodiment; equal parts are provided in the figures with equal reference characters. The figures of the drawing show as follows:

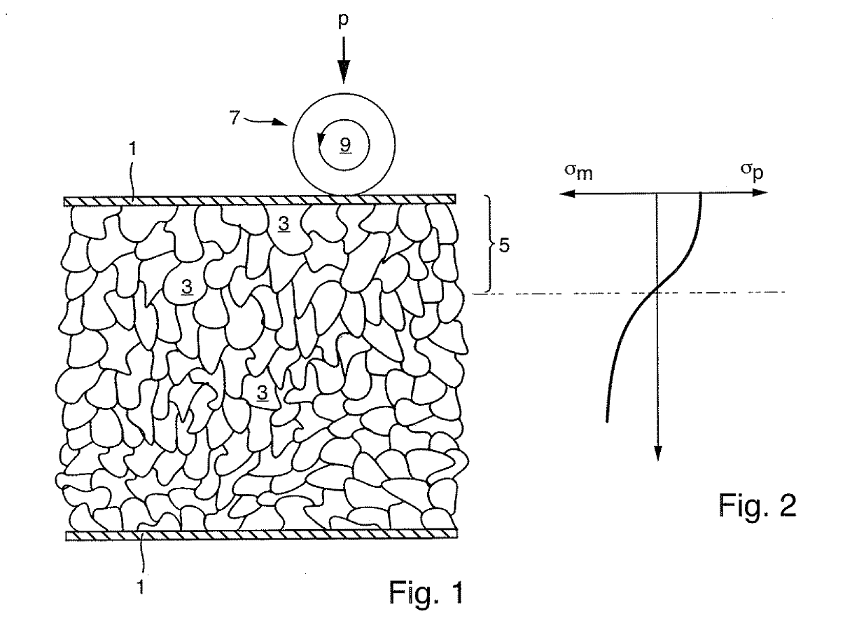

FIG. 1 a schematic view of an austenitic steel sheet;

FIG. 2 stresses present in the steel sheet; and

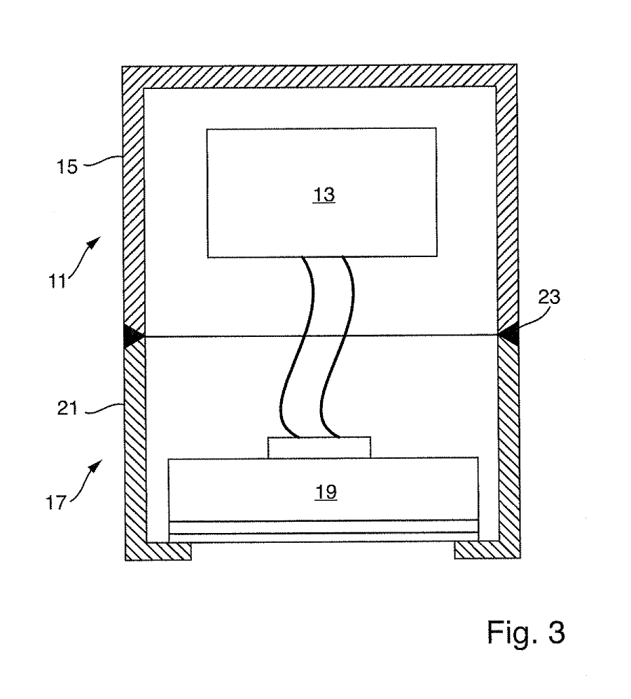

FIG. 3 a measuring device having an electronics housing connected via a weld seam with a sensor housing.

FIG. 1 shows a sketch of the principles of a steel component, wherein the steel is an austenitic, corrosion resistant steel.

As an example of an embodiment, here a section of a sheet of the steel is shown. The invention is, however, applicable also in connection with other steel components of corrosion resistant, austenitic steel, especially in connection with steel pipes or steel rods.

The steel is preferably a stainless steel and includes a comparatively high percentage of austenite formers selected as a function of the desired steel-properties and dissolved in the austenitic metal microstructure. Austenite formers include, for example, nickel, cobalt, manganese and nitrogen. Their percentage amounts preferably to greater than 10%.

For achieving a high corrosion resistance, the steel contains an addition effecting the corrosion resistance. Preferably, chromium is used for this, wherein the chromium fraction is usually greater than 10%. The addition forms a passive, oxide layer 1, especially a chromium oxide layer, on the steel surface. The oxide layer 1 has, for example, a thickness in the order of magnitude of one or more thousandths of a millimeter.

Located under the oxide layer 1 is a material structure of mutually adjoining grains 3, wherein precipitates, especially impurities, deposit at the grain boundaries of the individual grains 3. The grains 3, which are not illustrated here true to scale, have grain sizes in the order of magnitude of hundredths of a millimeter. The steel sheet, shown not true to scale in comparison to this, has, for example, a thickness of a number of millimeters.

According to the invention, the steel component is protected against stress corrosion cracking by introducing, by areal pressure exertion, compressive stresses σₚ into an outer layer 5 covered outwardly by the oxide layer 1.

These compressive stresses σₚ are preferably introduced by means of a roller burnishing device 7 here illustrated only schematically. The roller burnishing device 7 includes, for this, a pressure exerting element 9, which areally bears on an outside of the outer layer 5 and which is led under exertion of pressure p on the layer 5 over the outside of layer 5. The pressure exerting element 9 is preferably a cylindrical roller. Alternatively, also spheres can be applied, such as are also common in conventional roller burnishing devices. In order to assure an areal pressure exertion, the pressure exerting element 9, which is here not shown true to scale, preferably has a diameter in the order of magnitude of a number of millimeters or more.

Since the compressive stresses σₚ are areally introduced, layer 5 is not exposed to pointwise pressure loading. In this way, a transformation of the austenitic structure into deformation induced martensite is prevented. Therewith, the advantageous properties of the austenitic structure as regards corrosion resistance are kept.

As a function of the later application of the steel sheet, the compressive stresses σₚ are introduced in only one of the two outer layers 5 of the steel sheet or into both of the oppositely lying outer layers 5 of the steel sheet, in each case covered by one of the oxide layers 1.

The introduced compressive stresses σₚ superimpose on the residual stresses present in the outer layer 5 in the steel component and bring about in the outer layer 5 a predominating of the compressive stresses σₚ over tensile stresses present, in given cases, in the steel component. FIG. 2 shows the stress curve in the steel component perpendicular to its surface resulting after the introduction of the compressive stresses σₚ, wherein compressive stresses are presented as positive stresses σₚ and tensile stresses as negative, or minus, stresses σₘ.

If following the introduction of the compressive stresses the steel component is exposed to a medium that attacks the oxide layer 1, then, over time, microcracks can also occur here in the oxide layer 1. These, however, due to the compressive stress σₚ provided in the outer layer 5, no longer find tensilely stressed grain boundaries. The grain structure clearly holds together better due to the compressive stresses σₚ and counteracts growth of a microcrack along the grain boundaries.

For achieving a reliable stress corrosion cracking protection, the outer layer 5, in which the compressive stresses σₚ predominate, has preferably a thickness, which lies in an order of magnitude of greater than or equal to ten times the grain size of the grains 3 of the austenitic steel component. In the case of a grain size in the order of magnitude of hundredths of a millimeter, the thickness of the layer 5, thus, amounts to preferably one or more tenths of a millimeter.

The method of the invention is also applicable in the case of the manufacture of welded connections between two austenitic steel components having an outer oxide layer, especially a chromium oxide layer. In such case, the steel components to be connected are welded together along a weld seam. During cooling of the weld seam, also tensile stresses form regularly in the weld seam. Subsequently superimposed on these tensile stresses are compressive stresses σₚ, which are introduced into an outer layer of the weld seam by areal pressure exertion.

The stress corrosion cracking resistant steel components of the invention are suited especially as outer walls of housings, especially of device, or measuring device, housings, which are intended to be applied durably in halide containing environments. For this, preferably steel sheets of the invention with a sheet thickness in the order of magnitude of a few millimeters are applied.

FIG. 3 shows an example of an embodiment for this involving a measuring device having an electronics housing 11 for accommodating a measuring electronics 13 and a cylindrical outer wall 15 of a corrosion resistant, austenitic steel sheet, in whose outer layer covered outwardly by an oxide layer 1, especially a chromium oxide layer, areally introduced, compressive stresses are present. The electronics housing 11 is connected with a sensor housing 17 for accommodating a sensor 19. Sensor housing 17 likewise has a cylindrical outer wall 21 of a corrosion resistant, austenitic steel sheet, in whose outer layer covered outwardly by an oxide layer 1, especially a chromium oxide layer, areally introduced, compressive stresses are present. The connection of the two housing parts occurs via a weld seam 23 connecting the outer wall 15 of the electronics housing 11 with the outer wall 21 of the sensor housing 17. Present likewise in the outer layer of the weld seam 23 are areally introduced, compressive stresses.

Since the insides of the outer walls 15, 21 of the electronics and sensor housings 11, 17 at the location of use are not, as a rule, exposed to the halide containing environment, it suffices that compressive stresses are present only in the respectively outwardly facing outer layers of the outer walls 15, 21. The inwardly facing outer layers of the two outer walls 15, 21 have no need for compressive stresses to be present.

Preferably, areally introduced, compressive stresses σₚ are present in all outer layers of the outer walls 15, 21 and the weld seam 23 coming in contact with the halide containing environment. It is, however, alternatively also possible, with targeting, to protect against stress corrosion cracking by the introduction of compressive stresses only individual outer walls 15, 21 and/or only the weld seam 23.

### LIST OF REFERENCE CHARACTERS

1 oxide layer
3 grain
5 outer layer of the steel component
7 roller burnishing device
9 pressure exerting element
11 electronics housing
13 measuring electronics
15 outer wall of the electronics housing
17 sensor housing
19 sensor
21 outer wall of the sensor housing
23 weld seam

1-8. (canceled)

9. A method for producing steel components of corrosion resistant, austenitic steel protected relative to stress corrosion cracking and having an outer oxide layer, especially a chromium oxide layer, especially steel components in the form of steel sheets, steel pipes or steel rods, comprising the step of:
introducing compressive stresses into at least one outer layer of the steel component covered outwardly by the oxide layer, wherein:
the compressive stresses are introduced by areal pressure exertion on the outer layer.

10. The method as claimed in claim 9, wherein:
the compressive stresses are introduced by means of a roller burnishing device, which has a pressure exerting element, which bears areally on an outside of the outer layer and which is led, while exerting pressure on the layer, over its outside.

11. The method as claimed in claim 9, wherein:
the compressive stresses are introduced in such a manner that:
the layer has a thickness, which lies in an order of magnitude of greater than or equal to ten times a grain size of grains present in the steel component, and
the compressive stresses introduced in the layer outweigh existing tensile stresses.

12. A method for manufacturing a welded connection between two steel components of corrosion resistant, austenitic steel having an outer oxide layer, especially a chromium oxide layer, especially steel components in the form of steel sheets, steel pipes or steel rods, the method comprising the steps of:
the steel components are welded with one another along a weld seam; and
compressive stresses are introduced into an outer layer of the weld seam by areal pressure exertion.

13. A steel component of corrosion resistant, austenitic steel, especially a steel sheet, a steel tube or a steel rod, comprising:
which has an outer oxide layer, especially a chromium oxide layer; and
which has, outwardly covered by the oxide layer, at least one outer layer, in which areally introduced, compressive stresses are present.

14. The steel component as claimed in claim 12, wherein:
said layer has a thickness, which lies in an order of magnitude greater than or equal to ten times a grain size of grains present in the steel component; and
the introduced compressive stresses outweigh tensile stresses existing in said layer.

15. A housing, having:
at least one outer wall of a corrosion resistant, austenitic steel, which has, outwardly covered by an oxide layer, especially a chromium oxide layer; and
an outer layer, in which areally introduced, compressive stresses are present.

16. A housing, having:
two outer walls of corrosion resistant, austenitic steel connected with one another via a weld seam;
each of which has an outer layer covered outwardly by an oxide layer, especially a chromium oxide layer, wherein:
in an outer layer of the weld seam compressive stresses are present introduced by areal pressure exertion.
